(19) United States
(12) Patent Application Publication
(10) Pub. No.: US 2023/0315804 A1
(43) Pub. Date: Oct. 5, 2023

(54) INFORMATION PROCESSING DEVICE AND PROGRAM

(71) Applicant: Shin KOIKE, Miyoshi-shi (JP)

(72) Inventor: Shin KOIKE, Miyoshi-shi (JP)

(21) Appl. No.: 18/022,796

(22) PCT Filed: Sep. 11, 2020
(86) PCT No.: PCT/JP2020/034566

§ 371 Date: Feb. 23, 2023

(51) Int. Cl. G06F 17/15

(52) U.S. Cl. CPC G06F 17/15

(57) ABSTRACT

A result of calculation for a plurality of parameters with distribution is obtained with higher accuracy than conventional calculation in an information processor that acquires first and second input distributions of first and second input parameters. A first partial region is set in a range of an output distribution of an output parameter using the first and second input parameters. A value of a distribution for the first value is obtained, based on a value of a distribution of the first input parameter corresponding to the first value and a value of a distribution of the second input parameter corresponding to the first value within an input parameter range determined based on the first and second input distributions, and on a size of a second partial region that is included in the input parameter range and corresponds to the first partial region and a size of the first partial region.

### TECHNICAL FIELD

The present invention relates to an information processing device and a program.

### BACKGROUND ART

Conventionally, when a calculation is performed using a plurality of parameters and each of the parameters has variation (distribution), even if each of the parameters is processed as a distribution with the number of data pieces of the parameter increased, the distribution has failed to be obtained accurately, and thus the calculation has failed to be performed accurately in accordance with the variation of the parameters. This is an inherent limitation of arithmetic calculations. The calculation for parameters with distribution can only be performed accurately through distribution calculation based on the distribution of each of the plurality of parameters. The distribution calculation is known as convolutional integral. Patent Literature 1 discloses a technique of obtaining probability distribution data using convolutional calculation.

### CITATIONS LIST

### Patent Literature

Patent Literature 1: JP2002-230225A

### SUMMARY OF INVENTION

### Technical Problems

However, the convolutional calculation and calculus calculation are defined for a continuous function, and thus cannot be applied to discrete data such as a distribution or a histogram extracted from actual big data.

In view of the above problem, an object of the present invention is to obtain a result of calculation for a plurality of parameters with distribution, with higher accuracy than conventional calculation.

### Solutions to Problems

An information processing device according to the present invention includes: an acquisition unit configured to acquire a first input distribution of a first input parameter and a second input distribution of a second input parameter; a setting unit configured to set a first partial region including a first value, in a range of an output distribution of an output parameter obtained through calculation using the first input parameter and the second input parameter; and a generation unit configured to obtain a value of a distribution for the first value, based on a value of a distribution of the first input parameter corresponding to the first value and a value of a distribution of the second input parameter corresponding to the first value within an input parameter range that is a range including the first input parameter and the second input parameter and determined based on the first input distribution and the second input distribution, and on a size of a second partial region that is included in the input parameter range and corresponds to the first partial region and a size of the first partial region.

Another aspect of the present invention is an information processing device including: an acquisition unit configured to acquire a first input distribution of a first input parameter and a second input distribution of a second input parameter; and a generation unit configured to generate a changed distribution by adding a unit change amount of the second input distribution to the first input distribution, and generate a minutely changed distribution corresponding to a minute change amount corresponding to the unit change amount based on the first input distribution and the changed distribution.

Another aspect of the present invention is a program causing a computer to function as: an acquisition unit configured to acquire a first input distribution of a first input parameter and a second input distribution of a second input parameter; a setting unit configured to set a first partial region including a first value, in a range of an output distribution of an output parameter obtained through calculation using the first input parameter and the second input parameter; and a generation unit configured to obtain a value of a distribution for the first value, based on a value of a distribution of the first input parameter corresponding to the first value and a value of a distribution of the second input parameter corresponding to the first value within an input parameter range that is a range including the first input parameter and the second input parameter and determined based on the first input distribution and the second input distribution, and on a size of a second partial region that is included in the input parameter range and corresponds to the first partial region and a size of the first partial region.

Another aspect of the present invention is a program causing a computer to function as: an acquisition unit configured to acquire a first input distribution of a first input parameter and a second input distribution of a second input parameter; and a generation unit configured to generate a changed distribution by adding a unit change amount of the second input distribution to the first input distribution, and generate a minutely changed distribution corresponding to a minute change amount corresponding to the unit change amount based on the first input distribution and the changed distribution.

### Advantageous Effects of Invention

According to the present invention, a result of calculation for a plurality of parameters with distribution can be obtained accurately.

### BRIEF DESCRIPTION OF DRAWINGS

FIG. 1 is a diagram illustrating a configuration of an information processing device according to a first embodiment.

FIG. 2 is a flowchart illustrating calculation processing.

FIG. 3 is a diagram illustrating addition processing.

FIG. 4 is a diagram illustrating calculation processing in a case of an N-dimensional input parameter.

FIG. 5 is a diagram illustrating calculation processing in a case of an N-dimensional input parameter.

FIG. 6 is a diagram illustrating a relationship between a correlation coefficient and an input parameter range.

FIG. 7 is a diagram illustrating subtraction.

FIG. 8 is a diagram illustrating multiplication.

FIG. 9 is a diagram illustrating multiplication in a case of an N-dimensional input parameter.

FIG. 10 is a diagram illustrating division.

FIG. 11 is a diagram illustrating division in a case of an N-dimensional input parameter.

FIG. 12 is a diagram illustrating integral calculation processing.

FIG. 13 is a diagram illustrating integral calculation processing.

FIG. 14 is a diagram illustrating processing for obtaining durability.

FIG. 15 is a diagram illustrating route simulation.

FIG. 16 is a diagram illustrating an example of a display screen.

FIG. 17 is a diagram illustrating variation in component dimension.

FIG. 18 is a diagram illustrating variation in component dimension.

FIG. 19A is a diagram illustrating arithmetic calculation and distribution calculation.

FIG. 19B is a diagram illustrating arithmetic calculation and distribution calculation.

### DESCRIPTION OF EMBODIMENTS

Now embodiments are described in the following order.
(1) Arithmetic calculation and probability distribution calculation:
(2) Configuration of information processing device according to first embodiment:
(3) Calculation processing:
(4) Other embodiments:

### (1) Arithmetic Calculation and Probability Distribution Calculation

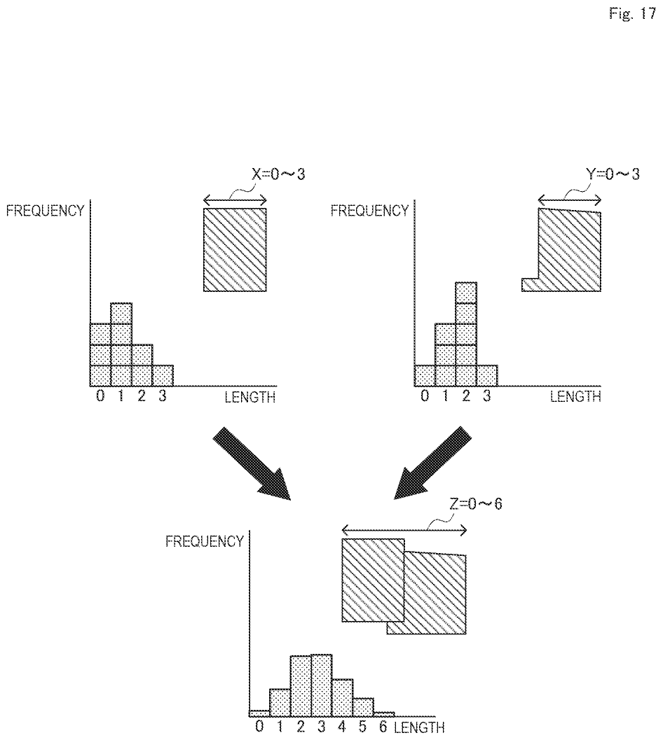

Prior to description of an information processing device according to the first embodiment, arithmetic calculation and probability distribution calculation will be described. When a calculation is performed for parameters with values distributed, a correct result cannot be obtained using numerical values of about a sample amount. FIG. 17 illustrates an example case to be considered where a third component having a dimension Z (Z=X+Y) is produced by combining a first component having a dimension X and a second component having a dimension Y. It is assumed here that there are 10 first components and 10 second components, with each of these types of components having variation (distribution) from 0 to 3. In this case, the dimension of the third component has a variation from 0 to 6.

A probability distribution having a total area of 1.0 is formed with 10 blocks a height of each of which, defining a frequency value in the vertical axis, being 0.1. An upper left graph in FIG. 17 is a probability distribution of the first component and an upper right graph in FIG. 17 is a probability distribution of the second component. A lower graph in FIG. 17 that is a probability distribution of the third component is obtained from these probability distributions. For example, the following three combinations result in the third component having the dimension Z of +2.

(X=0,Y=2)

(X=1,Y=1)

(X=2,Y=0)

As can be seen in (Formula 1), the sum of probabilities of these three combinations is the probability of the dimension Z of the third component being +2. Note that the correlation coefficient can be regarded as zero.

P(2)=3*0.1*0.1+4*0.1*3*0.1+2*0.1*1*0.1 (Formula 1)

By performing the above calculation on all the values of Z, the probability distribution of Z as illustrated in the lower diagram in FIG. 17 is obtained. The sum of the probability values of this distribution is 1.0. The basic idea of the probability distribution calculation is as described above.

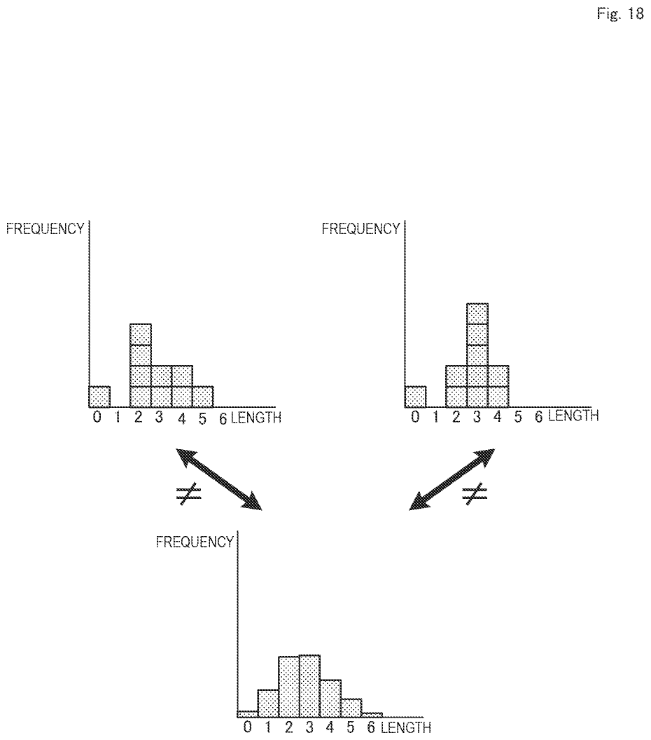

Next, a distribution is obtained as a sum of the values of the respective variations in various combinations of the first component and the second component. Two upper graphs in FIG. 18 are probability distributions in a case where X and Y are random, that is, a case where the correlation coefficient can be regarded as zero. The lower graph in FIG. 18 is the same as the lower graph in FIG. 17. The upper left graph in FIG. 18 and the upper right graph in FIG. 18 are each supposed to be the same probability distribution as the lower graph in FIG. 18, but are each actually different from one in the lower graph. Thus, calculation on individual data results in a probability distribution differing among data combinations, meaning that the distribution cannot be guaranteed.

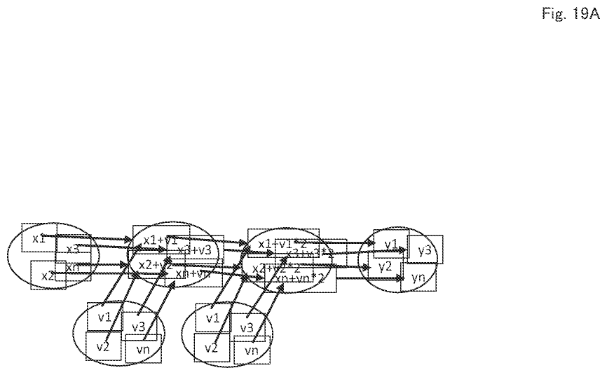

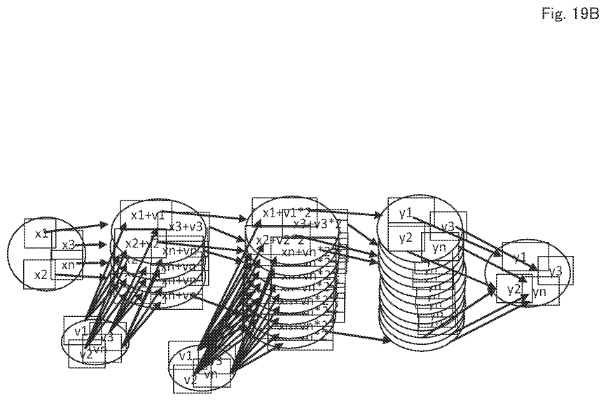

A description is further given on an arithmetic calculation with a larger number of data pieces and operations. FIG. 19A illustrates a case where a position and a velocity (x,v) of a moving object in an x direction are acquired n times by a recognition sensor, and n positions after t seconds are obtained by the calculation in (Formula 2).

y=x+v*t (Formula 2)

In FIG. 19A, one frame indicates n datasets, and n arrows indicate that calculation in (Formula 3) is performed n times with t=2.

y=x+v+v (Formula 3)

Assuming that i, j, and k are any values from 1 to n, this one arrow indicates a combination of a position, a velocity after one second, and a velocity after two seconds as can be seen in (Formula 4).

(x(i),v(j),v(k)) (Formula 4)

Actually, there is a certain possibility regarding a certain x position, allowable by the correlation among v(1) to v(n), meaning that the calculation illustrated in FIG. 19A results in certain 0 to (n−1) combinations missing. Furthermore, regarding a position (x+v+v) one second after each (x+v), there is a possibility of v allowing each (x+v), and combinations of such are missing.

FIG. 19B illustrates all the combinations missing in FIG. 19A. In this example, n**3 combinations are required at the most. The maximum combinations are obtained with the correlation coefficient close to 0 corresponding to an example where a vehicle position of which is x(i) and velocity of which is v(k), has the velocity v(k) varying in a range from v(0) to v(n) a second later. Actually, the velocity v(k) is less likely to vary largely, and is anticipated to be limited within a certain range around v(k).

The probability distribution calculation is a method of calculation obtaining a result with the probability of occurrence of these combinations incorporated as a probability distribution reflecting an impact of the correlation coefficient if necessary. In other words, the probability distribution calculation is a method of performing interpolation for information on a combination that fails to be covered by the arithmetic calculation with individual data. A larger number of calculations and parameters leads to a larger amount of combination missing, which is assumed to be a reason for a failure to guarantee the probability value with Monte Carlo simulation or the like. In view of the above, when performing calculation for a plurality of input parameters, the information processing device 100 according to the present embodiment performs the calculation after dividing a range of an input parameter distribution. Thus, a calculation result can be obtained with high accuracy.

### (2) Configuration of Information Processing Device According to First Embodiment

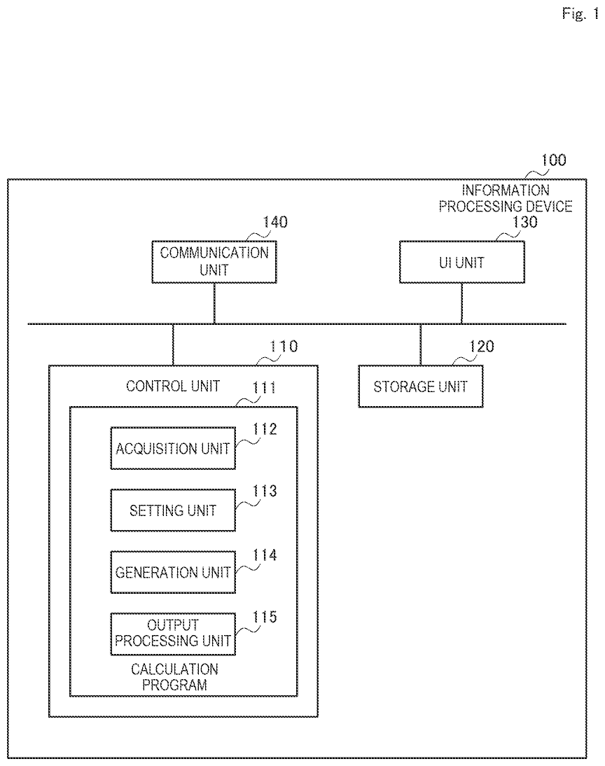

An information processing device 100 of the present embodiment will be described below. FIG. 1 is a block diagram illustrating a configuration of the information processing device 100 according to the present embodiment. The information processing device 100 includes a control unit 110, a storage unit 120, a UI unit 130, and a communication unit 140. The control unit 110 includes a CPU, a ROM, a RAM, and the like (not illustrated), and controls each unit of the information processing device 100 with the CPU executing various programs recorded in the ROM or the like using the RAM or the like. The control unit 110 may be formed by a single chip or a plurality of chips. In the control unit 110, an ASIC may be used instead of the CPU. Furthermore, in the control unit 110, the CPU and other processing circuits such as an ASIC and a GPU may operate in cooperation.

The storage unit 120 is, for example, a hard disk, and stores various types information and various programs. The communication unit 140 includes a communication interface circuit for communicating with other devices in wired or wireless connected with the information processing device 100, based on various communication protocols. The UI unit 130 includes a touch panel type display, as well as various keys and switches and the like.

The control unit 110 of the present embodiment performs a calculation for two or more input parameters to obtain an output parameter. It is assumed here that the value of the input parameter has variation, that is, distribution, and the value of the output parameter also has variation, that is, distribution. Thus, the input parameter and the output parameter each have a range of values, and in the range of the parameter, a value of the distribution corresponding the parameter is obtained. Here, the value of the distribution is a value an integrated value obtained from which corresponds to a probability value. In the present embodiment, a description is given using an example where a distribution of an output parameter z is obtained from input parameters x and y. The distributions of x and y are each an input distribution, and the distribution of z is an output distribution. Two or more input parameters are each assumed to be a one-dimensional parameter.

The control unit 110 processes such parameters with distribution. Specifically, the control unit 110 executes a calculation program 111 to function as an acquisition unit 112, a setting unit 113, a generation unit 114, and an output processing unit 115, to execute the processing. Processing described below to be executed by each functional unit is processing executed by the control unit 110 executing the calculation program 111.

The acquisition unit 112 acquires two input parameters. Specifically, the acquisition unit 112 acquires, for example, the two input parameters via the communication unit 140. The setting unit 113 sets the distribution range of the output parameter based on the distribution range of each of the two input parameters. Then, the setting unit 113 sets each value of the output parameter within the range of the distribution of the output parameter as a processing target, and sets a first partial region for the processing target value. The first partial region is a range of the output parameter, set for obtaining a probability value corresponding to the value of the output parameter. The first partial region is assumed to be set in advance. Based on the first partial region, the generation unit 114 obtains a probability value with each value of the output parameter. The generation unit 114 obtains the distribution of the output parameter from the probability values corresponding to all the values within the range of the output parameter. The output processing unit 115 outputs the distribution of the output parameter. Note that processing executed by each function will be described in detail later.

### (3) Calculation Processing

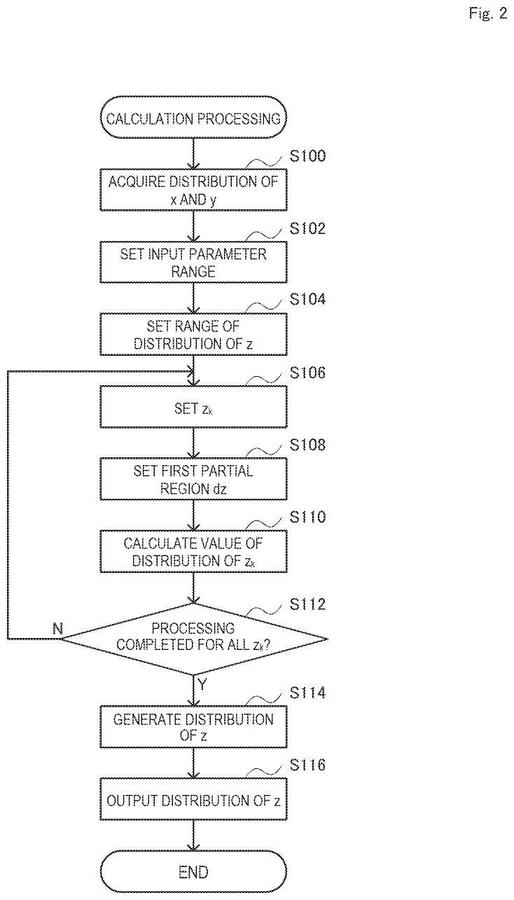

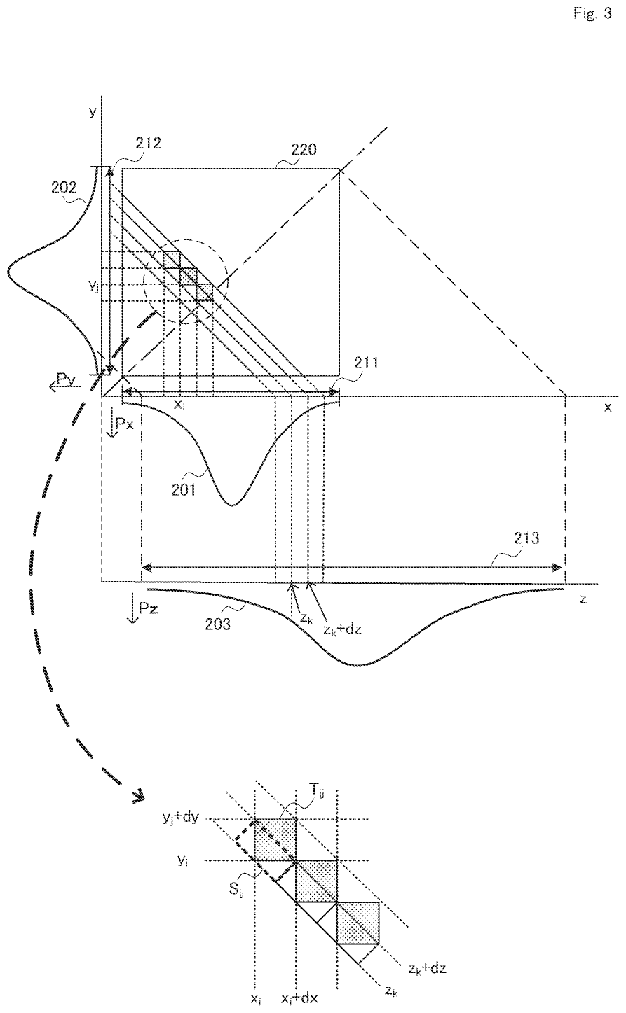

FIG. 2 is a flowchart illustrating calculation processing executed by the control unit 110 of the information processing device 100. FIG. 3 is a diagram illustrating addition processing. The calculation processing will be described in an example where z is obtained through addition “x+y”. As illustrated in FIG. 3, an x-y plane that is a two-dimensional plane with the vertical axis corresponding to x and the horizontal axis corresponding to y will be considered. A z axis is set to be parallel to the x axis on a plane that is the same as the two-dimensional plane. The parameters x and y on the respective axes each has distribution (variation). In this case, z obtained from x and y also has distribution. The distribution of x and y corresponds to the input distribution, and the distribution of z corresponds to the output distribution.

In FIG. 3, the distribution of x is illustrated as a graph 201 in which a direction orthogonal to the x axis and opposite to the y axis is a positive direction. The distribution of y is illustrated as a graph 202 in which a direction orthogonal to the y axis and opposite to the z axis is a positive direction. The distribution of z is illustrated as a graph 203 in which a direction orthogonal to the z axis and opposite to the y axis is a positive direction. The distribution of z spreads to values larger than the maximum value of the distribution of x. Values of the distribution of x, y, and z are denoted as Px, Py, and Pz, respectively.

With the calculation processing illustrated in FIG. 2, the distribution of z is obtained from the distributions of x and y. In the calculation processing, first of all, the acquisition unit 112 acquires the input parameter distribution, that is, the distributions of x and y (step S100). Next, the setting unit 113 sets a range of combination of x and y, that is, an input parameter range 220, based on an x distribution range 211 and a y distribution range 212 (step S102). The setting unit 113 sets the input parameter range as a range including all combinations of x and y to be the values of z. Here, the correlation coefficient is regarded as zero. In the example of FIG. 3, the input parameter range 220 is set as a range in the x-y two-dimensional plane and as a range with the maximum area determined by the x distribution range and the y distribution range.

Next, the setting unit 113 sets a z distribution range 213, based on the x distribution range 211 and the y distribution range 212 (step S104). The value of “x+y” is a constant value on a straight line with a slope “−1”, and the value of x at the point where the straight line intersects the x axis is the value of z. More specifically, a value of x at the point on the straight with the slope “−1” where a straight line in contact with the lower left point of the input parameter range 220 intersects the x axis is the minimum value of z, and a value of x at the point on the straight line with the slope “−1” where a straight line in contact with the upper right point of the input parameter range is the maximum value of z intersects the x axis is the maximum value of z. Under this condition, the z distribution range 213 is set on the z axis illustrated to be parallel to the x axis as illustrated in FIG. 3.

Next, the generation unit 114 sets a value zₖ of z (step S106). The processing in steps S106 to S112 is loop processing, and the generation unit 114 sets, as the value zₖ that is the processing target, values of z from the minimum value of z to the maximum value of z one by one in step S106. The values zₖ are numerical values at an equal interval, as a result of dividing a section from the minimum value of z to the maximum value of z by a predetermined number. As another example, zₖ may be a value corresponding to the unit of z. For example, when z is a length, a value in units of 1 mm may be set. Next, the generation unit 114 sets the first partial region for zₖ (step S108). Here, a range (size) dzz of the first partial region is a minute range, and zₖ is included in the first partial region. In the present embodiment, the generation unit 114 sets as a range dz of the first partial region for zₖ as a range from zₖ to zₖ₊₁. Thus, the range dz of the first partial region has the same width, that is, the same length regardless of the value of z.

Next, the generation unit 114 obtains the value of the zₖ distribution (step S110). This processing will be described below. The generation unit 114 first sets a second partial region Sᵢⱼ corresponding to the range dz of the first partial region. This second partial region Sᵢⱼ is a region in the x-y plane, and corresponds to the first partial region.

First of all, a description is given on the second partial region Sᵢⱼ. The value of “x+y”, that is, the value of z is constant on the straight line with the slope “−1”. A combination of x and y on the straight line with a slope “−1” (the straight line connected to a dotted line extending from zₖ in FIG. 3) passing through (x,y)=(zₖ,0) corresponds to the z value zₖ. Such x and y values are respectively referred to as xᵢ and yⱼ. The ranges of x and y corresponding to dz are respectively referred to as dx and dy.

The lower side in FIG. 3 is an enlarged view of the second partial region Sᵢⱼ. As illustrated in the lower side in FIG. 3, the second partial region Sᵢⱼ is a rectangular region defined by a straight line with a slope “−1” corresponding to zₖ, a straight line with a slope “−1” corresponding to “zₖ+dz”, a straight line with a slope “+1” passing through (xᵢ,yⱼ+d_{y}), and a straight line with an slope “+1” passing through (xᵢ+dx,yⱼ). This straight line with a slope “+1” passing through (xᵢ,yⱼ+dy) and a straight line with a slope “+1” passing through (xᵢ+dx,yⱼ) are auxiliary lines for setting the second partial region Sᵢⱼ. Thus, the second partial region Sᵢⱼ is a region, in the input parameter range 220, defined by two straight lines with a slope “−1” on which a value of the output parameter is constant, and two auxiliary lines parallel to each other.

The value Pz of the distribution of zₖ can be expressed as in (Formula 5) using the range dz of the first partial region and an area (size) aᵢⱼ of the second partial region Sᵢⱼ.

Pz(zₖ)*dz=ΣPx(xᵢ)*Py(yⱼ)*aᵢⱼ (Formula 5)

Furthermore, assuming that (Formula 6) is satisfied, the area aᵢⱼ of the second partial region Sᵢⱼ is the same as an area bᵢⱼ of a rectangular region Tᵢⱼ.

dx=dy=dz (Formula 6)

As illustrated in FIG. 3, the rectangular region Tᵢⱼ is a rectangular region defined by a straight line of x=xᵢ, a straight line of x=xᵢ+dx, a straight line of y=yⱼ, and a straight line of y=yⱼ+dy. Thus, the rectangular region Tᵢⱼ is a rectangular region on plane coordinates obtained by dividing each of x and y at an equal interval. From the above, (Formula 5) can be expressed as (Formula 7). The generation unit 114 obtains the value Pz of distribution of zₖ using (Formula 7). Note that (Formula 7) is obtained by performing replacement in (Formula 8), in (Formula 5) and dividing both sides by dz.

[Math 2]

aᵢⱼ=bᵢⱼ=dx*dy=dz2 (Formula 8)

The description is further given by referring back to FIG. 2. After the processing in step S110, the generation unit 114 checks whether the distribution values have been obtained for all zₖ (step S112). When there is unprocessed zₖ remaining (N in step S112), the generation unit 114 returns to step S106 and repeats the processing with the unprocessed zₖ set. When the distribution values have been obtained for all zₖ (Y in step S112), the generation unit 114 generates the distribution of z based on the distribution value for each zₖ (step S114). Specifically, the generation unit 114 generates a continuous distribution of z by using a least-squares method or the like for the values of the distribution corresponding the respective values of zₖ. Next, the output processing unit 115 outputs the distribution of z (step S116). Specifically, the output processing unit 115 displays the distribution of z on a display of the UI unit 130. Note that, as another example, the output processing unit 115 may transmit the distribution of z to an external device over a network.

In the manner described above, the information processing device 100 according to the present embodiment can accurately obtain calculation results for a plurality of parameters with distribution.

Note that the input parameter distribution may be continuous or may be discrete as in a histogram. When parameters with discrete values are acquired as the input parameters, the control unit 110 may performing interpolation for the values of the distribution of the parameters, and obtain the distribution of the output parameter using the parameters after the interpolation as the processing target. Thus, even if the input parameter is of discrete values, the information processing device 100 can accurately obtain the distribution of the output parameter through the calculation processing described with reference to FIG. 2 and the like.

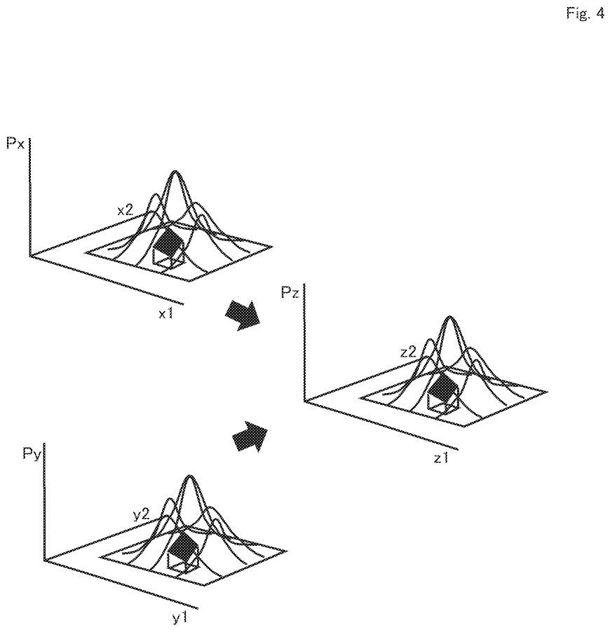

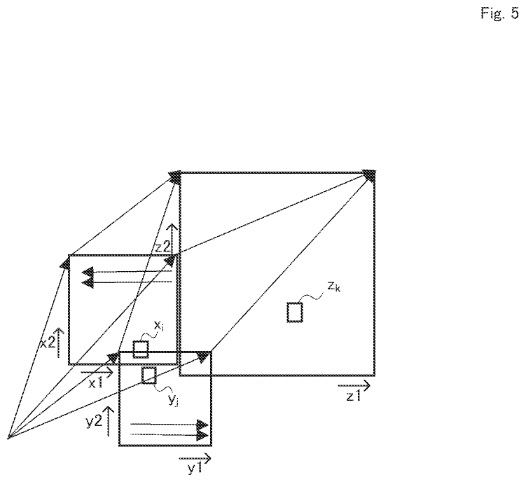

Next, with reference to FIGS. 4 and 5, a description is given on calculation processing in a case where each of the input parameters x and y is an N-dimensional parameter (N is an integer that is equal to or larger than 2). Such processing can be executed as an extension of the case of the one-dimensional parameter. Here, a description will be given on a two-dimensional parameter as an example. Two-dimensional x parameters, that is, two parameters are denoted by x1 and x2. Similarly, two-dimensional y parameters are denoted by y1 and y2, and the two-dimensional z parameters are denoted by z1 and z2. As in the case of the addition of the one-dimensional parameters described above, the second partial region Sᵢⱼ can be converted into the rectangular region Ti j. Thus, as illustrated in FIG. 5, the ranges of x, y, and z can be each considered as a rectangular region. The generation unit 114 obtains the distribution of z based on the rectangular regions determined by zₖ and dz in (Formula 9).

zₖ=(z1(m),z2(n)) (Formula 9)

Here, xᵢ and yⱼ corresponding to zₖ are expressed by (Formula 10) and (Formula 11), respectively.

xᵢ=(x1(s),x2(t)) (Formula 10)

yⱼ=(y1(q),y2(r)) (Formula 11)

When (Formula 12) and (Formula 13) are satisfied, the distribution of z is expressed by (Formula 14).

dz1=dx1=dy1 (Formula 12)

dz2=dx2=dy2 (Formula 13)

[Math 3]

Thus, the generation unit 114 can obtain the value Pz of distribution of zₖ using (Formula 14).

Note that, in a case where the input parameter is an N-dimensional parameter, the ranges dx and dy for the parameters of the corresponding dimension in the calculation, such as x1 and y1, are assumed to be equal values for example. The ranges dx and dy corresponding non-corresponding parameters in the calculation may be different values as in the case of x1 and x2.

Next, a description will be given on a calculation taking into correlation coefficient into consideration. While a case where the correlation coefficient can be regarded as zero is described above as an example, a non-zero correlation coefficient may be given. In such a case, the generation unit 114 sets the input parameter range based on the correlation coefficient. More specifically, a smaller input parameter range is set for a correlation coefficient closer to “−1”.

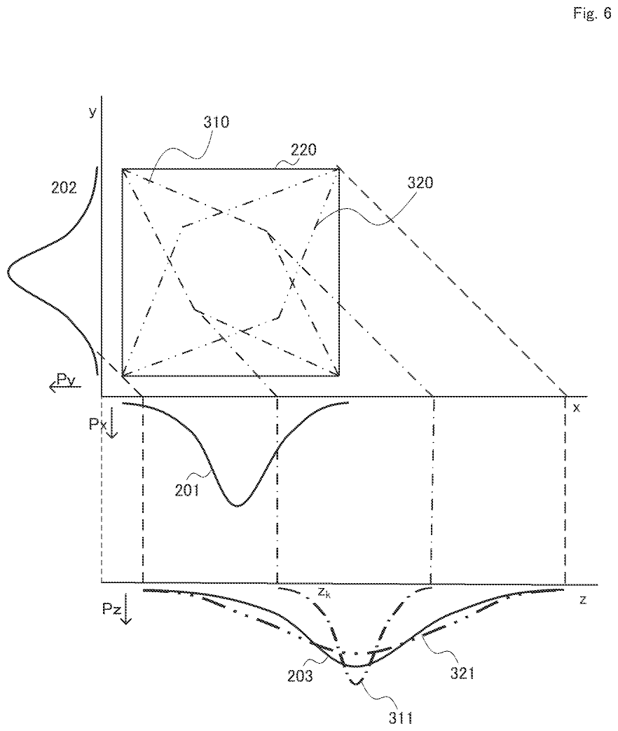

FIG. 6 is a diagram illustrating a relationship between a correlation coefficient and an input parameter range. As illustrated in FIG. 6, the input parameter range is set to be a range 310 indicated by a one-dot chain line in the figure, when a correlation coefficient r is “−0.6”. The input parameter range is set to be a range 320 indicated by a two-dot chain line in the figure, when the correlation coefficient r is “+0.6”. The ranges 310 and 320 are each a range smaller than the input parameter range 220 of the maximum range. With the input parameter range thus set to a smaller range, the value of the distribution of z can be obtained by a smaller amount of calculation. When the correlation coefficient is set to a negative value, the range of a distribution 203 of z becomes small as indicated by a distribution 311. When the correlation coefficient is set to a positive value, the range of the distribution 203 of z does not change as indicated by a distribution 321.

In the present embodiment, the generation unit 114 deforms the input parameter range into a rhombus shape, to limit the range of the region thereof. Note that the generation unit 114 only needs to reduce the area of the input parameter range according to the correlation coefficient, and thus the shape of the input parameter range after the deformation is not limited to that in the embodiment. As another example, the generation unit 114 may limit the input parameter range through deformation into an elliptical shape. The processing of thus limiting the input parameter range in accordance with the correlation coefficient can also be applied to subtraction, multiplication, and division described below.

A description is given below on subtraction, multiplication, and division. While processing of calculating the probability of zₖ in S110 differs among the for arithmetic operations, processing other than that is the same as that for addition. Thus, processing of calculating the probability of zₖ in each of cases of subtraction, multiplication, and division will be described below.

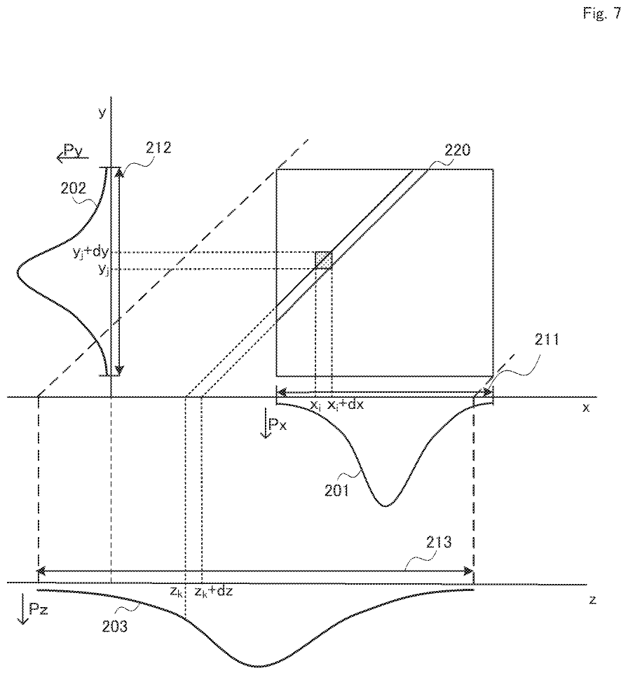

FIG. 7 is a diagram illustrating subtraction. Here, calculation of obtaining z by subtraction “x−y” will be described as an example. In the case of subtraction, the range of distribution of z is a range from the minimum value to the maximum value of “x−y”. Note that the input parameter range is the same among the four arithmetic operations.

The value of “z−y” is constant on the straight line with the slope “+1” on the x−y plane. Thus, as illustrated in FIG. 7, all the points, corresponding to the combinations of x and y, on a line within the input parameter range, in a straight line with the slope “+1” passing through an intersection between a dotted line extending from zₖ and the x axis are the combinations of x axis and y corresponding to zₖ. Such x and y values are respectively referred to as xᵢ and yⱼ. The ranges of x and y corresponding to dz are respectively referred to as dx and dy.

As illustrated in the lower side FIG. 7, the second partial region Sᵢⱼ is a rectangular region defined by a straight line with a slope “+1” corresponding to zₖ, a straight line with a slope “+1” corresponding to “zₖ+dz”, a straight line with a slope “−1” passing through (xᵢ, yⱼ), and a straight line with an slope “+1” passing through (xᵢ, yⱼ+dy). This straight line with a slope “−1” passing through (xᵢ, yⱼ) and a straight line with a slope “+1” passing through (xᵢ, yⱼ+dy) are auxiliary lines for setting the second partial region Sᵢⱼ. Thus, the second partial region Sᵢⱼ is assumed to be a region, in the input parameter range, defined by two straight lines with a slope “−1” on which the value of the output parameter is constant, and two auxiliary lines parallel to each other. Also in the case of subtraction, the area aᵢⱼ of the second partial region Sᵢⱼ is the same as an area biz of a rectangular region Tᵢⱼ. From the above, it can be understood that the distribution value Pz of zₖ is obtained by (Formula 7) also in the case of subtraction. Thus, the generation unit 114 can obtain the value Pz of the distribution of zₖ using (Formula 7) also in the case of subtraction.

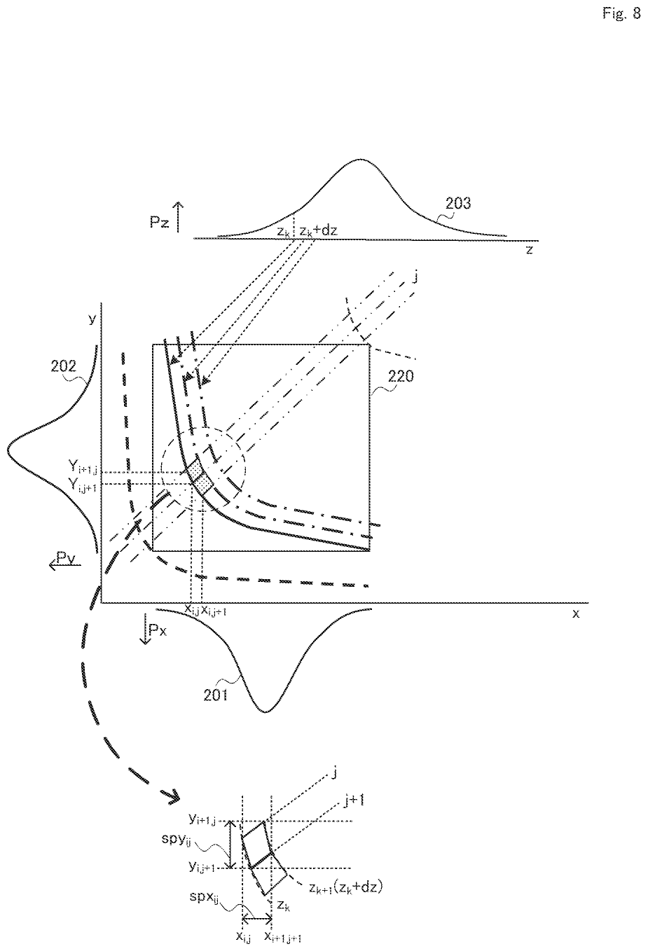

Next, a description will be given on multiplication with reference to FIG. 8. Here, calculation of obtaining z by multiplication “x*y” will be described as an example. Also in the case of multiplication, the distribution of z is a range from the minimum value to the maximum value of “x*y”. The value of “x*y” is constant on a hyperbola. In the case of multiplication, a straight line with a slope “+1” is set as an auxiliary line, and a region defined by two hyperbolas and two auxiliary lines having a slope of “+1” is set as the second partial region. Here, the two hyperbolas are a hyperbola corresponding to zₖ and a hyperbola corresponding to zₖ₊₁, and the two straight lines with the slope “+1” are a j-th straight line and a j+1-th straight line. These straight lines will be described later.

When m auxiliary lines are set at an equal interval in the input parameter range 220, (Formula 15) holds.

zmax−zmin=xmax*ymax−xmin*ymin=(m−1)*dz (Formula 15)

The j-th auxiliary line is expressed by (Formula 16). Here, da is assumed to be a constant value.

y=x+ymax−xmin−j*da (Formula 16)

The i-th hyperbola is expressed by (Formula 17). The hyperbola corresponding to the minimum value of zₖ is a hyperbola passing through (xmin, ymin) in the input parameter range 220, and the hyperbola corresponding to the maximum value of zₖ is a hyperbola passing through (xmax, ymax) in the input parameter range 220.

z=zmin+i*dz (Formula 17)

x_{i,j} and y_{i,j} are expressed by (Formula 18).

(x_{i,j},y_{i,j})=((−(ymax−xmin−j*da)±((ymax−xmin−j*da)**2+4*(zmin+i*dz))**0.5)/2,

((ymax−xmin−j*da)±((ymax−xmin−j*da)**2+4*(zmin+i*dz))**0.5)/2) (Formula 18)

Here, spx_{i,j} and spy_{i,j} are expressed by (Formula 19) and (Formula 20), and an area a_{i,j} of the second partial region S_{i,j} can be roughly obtained from spx_{i,j} and spy_{i,j}. The area a_{i,j} of the second partial region S_{i,j} is expressed by (Formula 21).

spx_{i,j}=x_{i+1,j+1}−x_{i,j} (Formula 19)

spy_{i,j}=y_{i+1,j}−y_{i,j+1} (Formula 20)=

a_{i,j}=(spx_{i,j}*spy_{i,j})/2 (Formula 21)

The second partial region S_{i,j} is a range defined by the i-th hyperbola, the “i+1”-th hyperbola, the j-th straight line, and the “j+1”-th straight line. The values of x_{i,j} and y_{i,j} are determined by i and j, and px(x_{i,j}) and Py(y_{i,j}) are obtained by interpolating x and y acquired from the input parameters.

The distribution of z can be obtained as a sum of values of distributions of the combinations of i and j as in (Formula 22). Note that the right side of (Formula 22) is addition for j.

[Math 4]

When the origin is in a z plane, the calculation can be performed by setting different auxiliary lines in the positive region and the negative region.

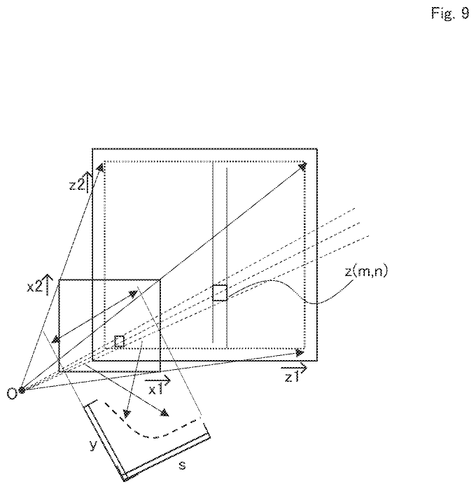

Next, a description will be given on multiplication between an N-dimensional input parameter and a one-dimensional input parameter. Here, with reference to FIG. 9, multiplication between a two-dimensional input parameter x and a one-dimensional input parameter y will be described as an example. In this case, a two-dimensional z plane obtained by calculation, that is, a two-dimensional plane having z1 and z2 as axes is set. Further, the origin O and the x plane are set. The x plane is a two-dimensional plane having x1 and x2 as axes.

Here, the z plane is divided into a plurality of partial regions, and a partial region to be processed is defined as z(m, n). The generation unit 114 sets, as an s axis, a straight line overlapping the x plane in a straight line connecting z(m, n) and the origin O. Thus, the value of s includes x1 and x2 components. Further, the y axis is set to be orthogonal to the s axis, and a hyperbola satisfying z(m, n) in the two-dimensional plane defined by s and y is set. Then, the generation unit 114 performs the calculation in (Formula 22) at a point on the hyperbola. As a result, the value of the distribution of z(m, n) can be obtained.

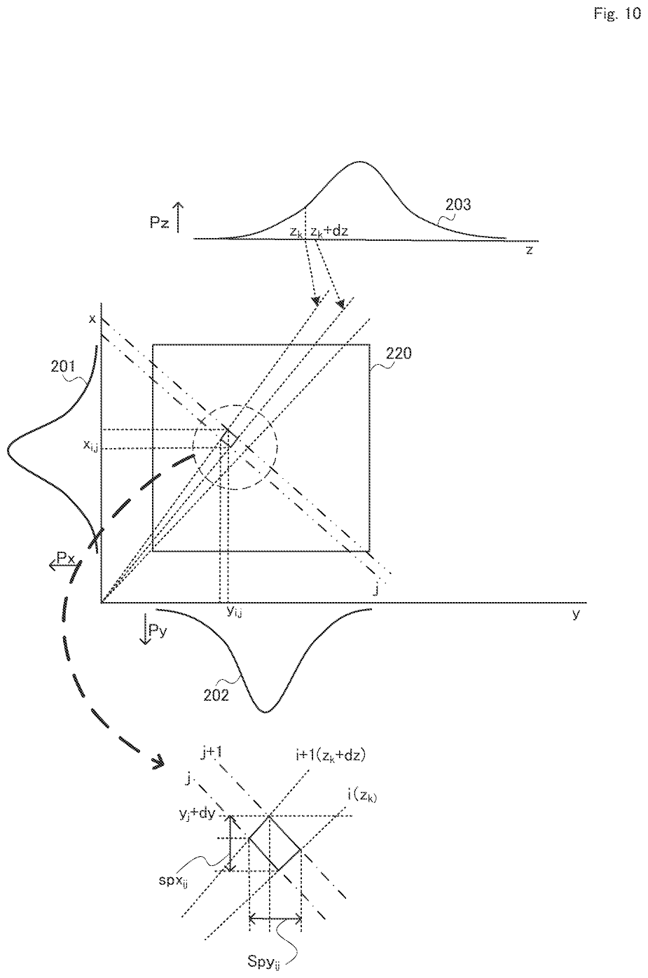

Next, a description will be given on division with reference to FIG. 10. In FIG. 10, x and y indicates the vertical axis and the horizontal axis respectively. Here, calculation of obtaining z by division “x/y” will be described as an example. Also in the case of division, the distribution of z is a range from the minimum value to the maximum value of “z/y”. The value of “x/y” is constant on a straight line passing through zero. In the case of division, a straight line with a slope “−1” is set as an auxiliary line, and a region defined by two straight lines on which the value of “x/y” is constant and two straight lines having an inclination of “−1” is set as the second partial region. The two straight lines on which the value of “x/y” is constant are straight lines corresponding to zₖ and zₖ₊₁, and the two straight lines with the slope “−1” are a j-th straight line and a j+1-th straight line. These straight lines will be described later.

When m auxiliary lines are set at an equal interval in the input parameter range, (Formula 23) holds. Here, da is assumed to be a constant value.

xmax+ymax−(xmin+ymin)=(m−1)*da (Formula 23)

The j-th auxiliary line is expressed by (Formula 24).

x=−y+(ymin+xmin)+j*da=−y+(ymin+xmin)+j*(xmax+ymax−xmin−ymin)/(m−1) (Formula 24)

The i-th straight line corresponding to “x/y” is expressed by (Formula 25). Here, zₖ is a value the unit of which is one of n ranges obtained by equally dividing the range of the distribution of z. Here, dz is assumed to be a constant value. In the present embodiment, dz is assumed to be a range equal to “zₖ₊₁−zₖ”.

x=b(i)*y=(i*xmax/ymin+(n−1−i)*xmin/ymax)/(n−1)*y (Formula 25)

When z=b(i) holds, dz is expressed by (Formula 26).

dz=b(i+1)−b(i)=−((i+1)*xmax/ymin+(n−1−(i+1))*xmin/ymax)/(n−1)+(i*xmax/ymin+(n−1−i)*xmin/ymax)/(n−1)=(xmax/ymin−xmin/ymax)/(n-1) (Formula 26)

Based on (Formula 24), (Formula 27) holds.

b(i)*y=−y+(ymin+xmin)+j*da (Formula 27)

Here, x_{i,j} and y_{i,j} are expressed by (Formula 28) and (Formula 29) respectively.

y_{i,j}=((ymin+xmin)+j*da)/(b(i)+1)=((ymin+xmin)+j*da)/((i*xmax/ymin+(n−1−i)*xmin/ymax)/(n−1)+1) (Formula 28)=

x_{i,j}=((ymin+xmin)+j*da)/(1+1/b(i))=((ymin+xmin)+j*da)/((n−1)/(i*xmax/ymin+(n−1−i)*xmin/ymax)+1) (Formula 29)

Here, spx_{i,j} and spy_{i,j} are expressed by (Formula 30) and (Formula 31), and an area a_{i,j} of the second partial region S_{i,j} can be roughly obtained from spx_{i,j} and spy_{i,j}. The area a_{i,j} of the second partial region S_{i,j} is expressed by (Formula 32).

spxij=x(i+1,j+1)−x(i,j) (Formula 30)

spyij=y(i,j+1)−y(i+1,j) (Formula 31)=

a_{i,j}=(spx_{i,j}*spy_{i,j})/2 (Formula 32)

From the above, it can be understood that the distribution value Pz of zₖ is obtained by (Formula 22) also in the case of division. Thus, the generation unit 114 can obtain the value Pz of the distribution of zₖ using (Formula 22) also in the case of division.

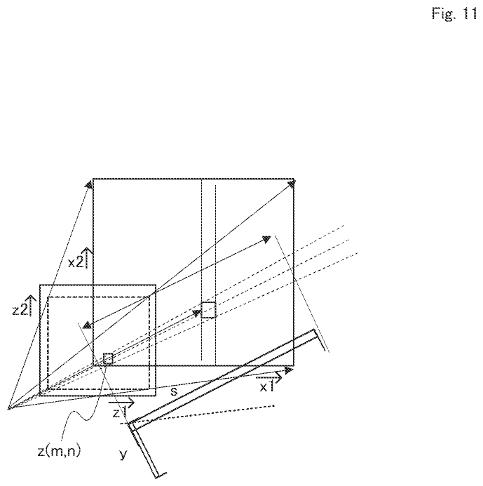

Next, a description will be given on division between an N-dimensional input parameter and a one-dimensional input parameter. Here, with reference to FIG. 11, division between a two-dimensional input parameter x and a one-dimensional input parameter y will be described as an example. In this case, processing similar that for the multiplication between N-dimensional and one-dimensional parameters may be performed.

As in the case of multiplication, the generation unit 114 sets the z plane and the x plane, and sets a partial region z(m,n) to be the processing target on the z plane. The generation unit 114 sets, as an s axis, a straight line overlapping the x plane in a straight line connecting z(m,n) and the origin O, and sets the y axis to be orthogonal to the s axis. The generation unit 114 sets a straight line satisfying z(m,n) on the two-dimensional plane defined by s and y. Then, the generation unit 114 performs the calculation in (Formula 22) at a point on the straight line, and obtains the probability for z(m,n). While the four arithmetic operations is described above in the case where the input parameter range 220 is located in the first quadrant of the graph, the slope of the auxiliary line may vary, in accordance with a straight line or a curve on which z is constant, among the quadrants in which each input parameter range 220 is located.

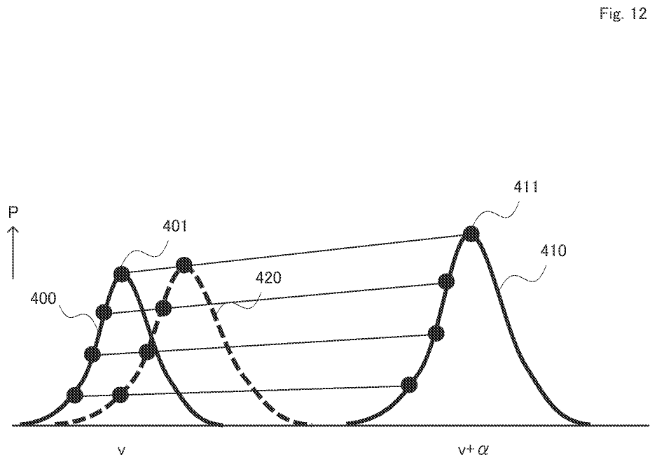

Next, a description will be given on integration with reference to FIG. 12. The description will be given on an example where a velocity v is obtained by integrating acceleration a. For example, it is anticipated that a change in the velocity v over time can be simulated, by creating distributions (minute distributions) with the acceleration a multiplied by a small value such as 0.01 and 0.001, and adding the distributions to the velocity v. However, while the distribution obtained by multiplication by 0.01 returns to the original distribution by summing 100 such distributions, such a distribution of minute multiples cannot be obtained because the distribution calculation is an irreversible operation. In view of this, the generation unit 114 of the present embodiment obtains a minutely changed distribution corresponding to minute change time shorter than unit change time, based on velocity v1, and velocity v2 after a unit change time of the acceleration a. The unit change time is an example of a unit change amount.

As described above, the distribution of minute multiples, that is, “a*dt” cannot be obtained. Thus, the generation unit 114 first obtains v1(v₀+α) that is the acceleration a after a lapse of the change unit time, from v₀. Here, the change unit time is a unit of change amount. For example, when the unit of the acceleration a is km/h², the change unit time is one hour. When integration is performed to obtain a position p from the velocity v with a unit of m/s, the change unit time is one second. Then, the generation unit 114 obtains “v₀+a*dt”, that is, a minutely changed distribution 420 through weighted averaging of a value 401 at the peak of a distribution 400 corresponding to the velocity v1 and a value 411 at the peak of a distribution 410 corresponding to the velocity v2. The generation unit 114 equally divides the distributions of velocity before and after the change unit time, in the direction of their heights up to the peak values, and obtains the weighted averages for each of the resultant points based on the 1:100 change unit time (1:100 in a case of the distribution of minute multiplication of 0.01 for example).

As another example, the generation unit 114 may obtain the distribution after the minute change, through weighted averaging of values of parameters after the division. While the unit change amount is described as time for example in the present embodiment, the unit change amount is not limited to time, and may be any value usable for integration.

In the case of integration, the generation unit 114 may perform the calculation with a negative correlation coefficient provided, when feedback control or the like is performed for example. Thus, the calculation results can converge to a constant value.

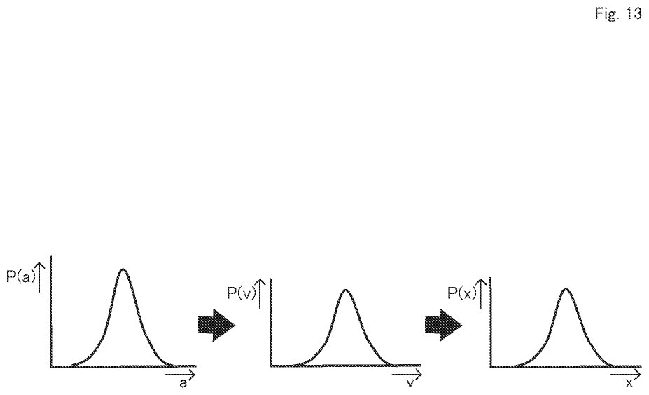

Furthermore, as illustrated in FIG. 13, the generation unit 114 can not only obtain the velocity from the acceleration through the integration, but can also obtain the position from the velocity. The formulae for the calculation are expressed by (Formula 33) and (Formula 34).

v=v0+a*dt (Formula 33)

x=x0+v*dt (Formula 34)

In this manner, the generation unit 114 can also perform integration parameters with distribution.

Next, calculation examples will be described. For example, as an example of multiplication, the control unit 110 of the information processing device 100 obtains the lifetime engine rotation count (times) using (Formula 35) based on the distribution (statistical data) of the engine rotation count (rotation times/min) during the voyage of a ship and the distribution (statistical data) of the lifetime voyage time.

Lifetime engine rotation count (times)=engine rotation count during voyage×lifetime voyage time (hours) (Formula 35)

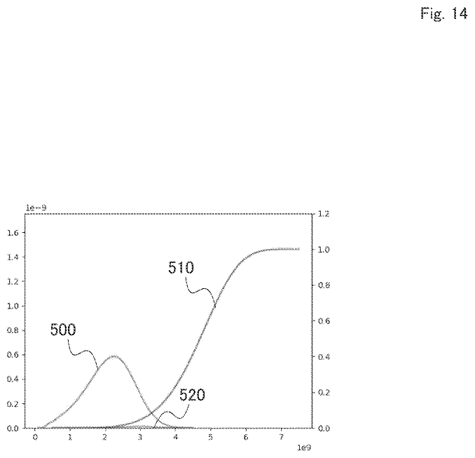

The control unit 110 further obtains a durability condition of the engine based on the lifetime engine rotation count. Specifically, the durability condition is obtained based on stress strength. FIG. 14 is a diagram illustrating processing for obtaining durability. FIG. 14 illustrates a lifetime rotation count distribution 500, a Weibull cumulative distribution 510, and a failure distribution 520. The graph has the horizontal axis representing the lifetime engine rotation count (times), the vertical axis on the left representing the probability of the engine rotation count, and the vertical axis on the right representing the cumulative probability of the strength. The lifetime rotation count distribution 500 obtained by (Formula 37) described above is defined as stress, and the Weibull cumulative distribution 510 is defined as strength. By integrating these, the failure distribution 520 is obtained.

The area of the failure distribution 520 represents the probability of failure. Thus, with the probability of failure serving as the target, the Weibull distribution can be determined to satisfy a certain probability of failure through the step described above. In order to guarantee the Weibull distribution, the durability condition can be obtained as follows. For example, the engine rotation count at 60% is 5.0×10⁹ times. Therefore, if there are three ships that do not break until the engine rotation count reaches 5.0×10⁹ times, it can be understood from (Formula 36) that the failure distribution 520 is guaranteed with the reliability of 93.6%. In this manner, the control unit 110 can determine durability.

1−(1−0.6)³=93.6% (Formula 36)

As an example of the division, the control unit 110 obtains the fuel consumption of an engine of a ship using (Formula 37), based on the distribution (statistical data) of a fuel consumption amount of the engine and a route distance (statistical data).

Fuel consumption=route distance/fuel consumption amount (Formula 37)

The control unit 110 may refer to a distribution of the fuel consumption thus obtained, and set a threshold for the fuel consumption, to determine that the engine is in an abnormal state when the fuel consumption is equal to or lower than the threshold and output warning display or the like.

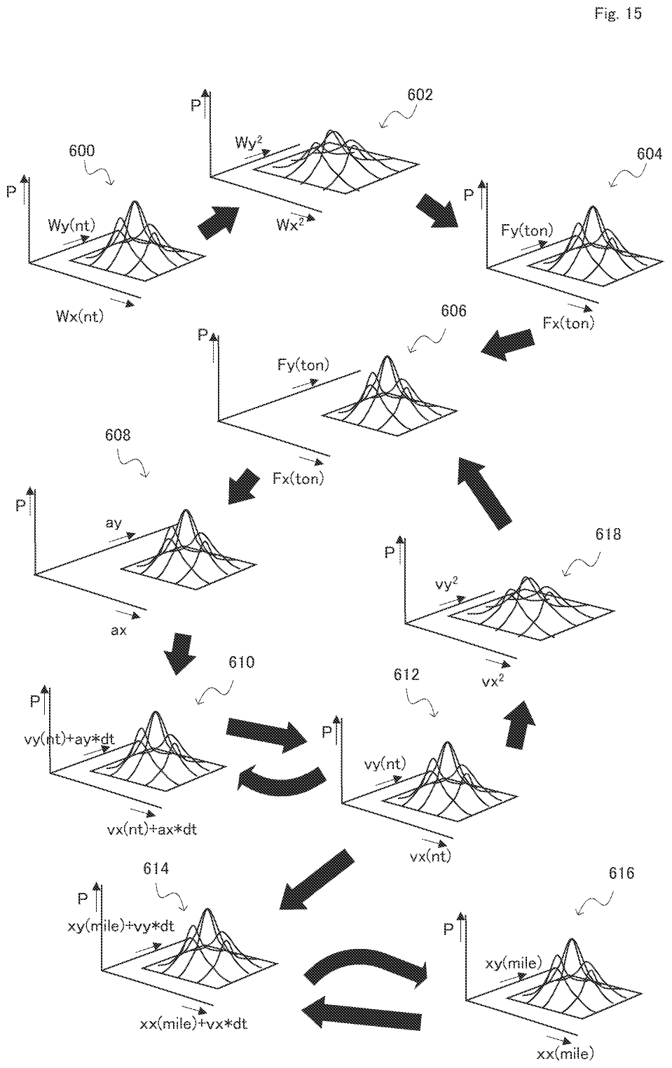

Next, specific processing for four arithmetic operations and integration will be described using a case where a route simulation of a ship is performed as an example. FIG. 15 is a diagram illustrating route simulation. Prior to the description, each parameter will be described. The parameters are as follows.
F: propulsion force=36000 tonmile/h²
m: weight=100 ton
a: acceleration mile/h² (720=0.1 m/s²)
v: velocity mile/h (initial velocity 10 nt)
g: force of wind=azimuth×wind force (2D distribution) 10 m/s=20 mile/h

The force related to the ship is expressed by (Formula 38). Note that c represents resistance.

F+g=m*a+c*v² (Formula 38)

Thus, the acceleration is expressed by (Formula 39).

a(t)=(F−g(t)−c*v²)/m (Formula 39)

As can be seen in (Formula 40), the velocity is obtained by integrating the acceleration with time.

v(t+1)=v(t)+a(t)*dt (Formula 40)

As illustrated in FIG. 15, the control unit 110 obtains a distribution 602 of the square (Wx², Wy₂) of wind velocity (Wx, Wy) from a distribution 600 of the wind velocity. The control unit 110 obtains a distribution 604 of force (Fx, Fy) received by the ship using (Formula 41).

Force received by ship (Fx,Fy)=wind receiving area*resistance area*square of wind velocity (Formula 41)

Furthermore, the control unit 110 adds the propulsion force and the resistance of water to the distribution 604 to obtain a distribution 606 of the total force applied to the ship. Next, the control unit 110 obtains a distribution 608 of acceleration (ax, ay) by dividing the distribution 606 by mass. Then, the control unit 110 obtains, by integration, a distribution 610 of velocity (vx(nt)+ax*dt, vy(nt)+ay*dt) after dt seconds by integration, and a distribution 612 of velocity (vx(nt), vy(nt)) after unit time. The control unit 110 further obtains a distribution 610 of the next velocity from the velocity distribution 612. In this manner, the control unit 110 obtains time series data of the velocity by repeatedly performing the calculation.

The control unit 110 also obtains a distribution 614 of a position (xx(mile)+vx*dt, xy(mile)+vy*dt) after dt seconds by integrating the distribution 612 of the velocity, and further obtains a distribution 616 of a position (xx(mile), xy(mile)) after unit time. Furthermore, the control unit 110 obtains a distribution 614 of the next position from the distribution 616 of the position. In this manner, the control unit 110 obtains time series data of the position by repeatedly performing the calculation.

The resistance of water described above is obtained by obtaining a distribution 618 of the square of the velocity (vx², vy²) and multiplying the distribution 618 of the square of the velocity by a resistance coefficient. This resistance of water is used for calculating the distribution 606 of the total force. The control unit 110 can predict changes in velocity and position over time in the route by repeating the above calculation.

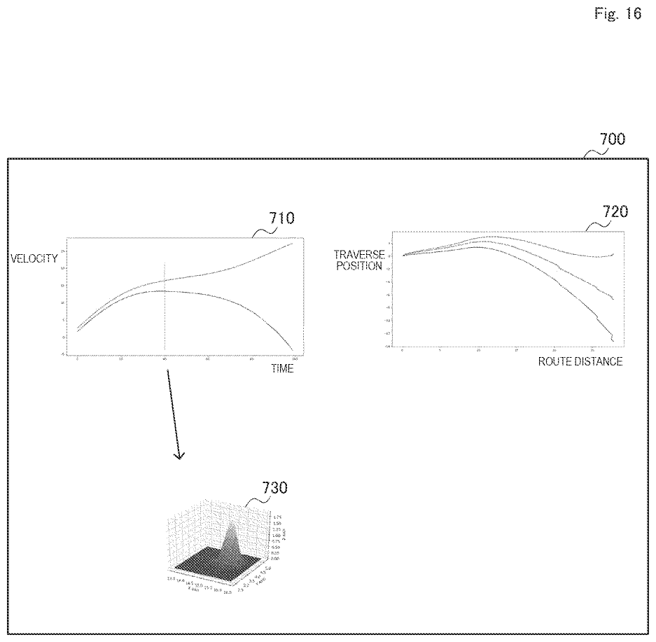

FIG. 16 illustrates an example of a display screen displayed on the UI unit 130 by the control unit 110. A display screen 700 displays a graph 710 indicating a change in velocity over time and a graph 720 indicating a position in a traverse direction according to the distance. The graph 710 has the horizontal axis indicating time and the vertical axis indicating velocity. The graph 710 illustrates a change in each of the upper and the lower limits over time in the velocity distribution obtained by the calculation described above. The graph 720 has the horizontal axis indicating the route distance and the vertical axis indicating a position in the traverse direction. This traverse direction is a direction orthogonal to the traveling direction in the route. The graph 720 illustrates the upper limit, the level, and the average of the positions obtained by the above calculation.

When predetermined time on the graph 710 is selected by a user operation, a 3D graph 730 indicating the distribution of the velocity at the selected time is displayed. The graph 730 has the horizontal axis indicating the left-right direction and front-back direction, and the vertical axis indicating probability.

As described above, the control unit 110 can predict the velocity and the position on the route and display these pieces of information. Furthermore, the control unit 110 performs the calculations by distribution calculation, and thus can display a calculation result with distribution. In the manner described above, the information processing device 100 according to the present embodiment can accurately obtain calculation results for a plurality of parameters with distribution.

### (4) Other Embodiments

The above embodiment is an example of implementation the present invention, and various other embodiments can be adopted. For example, the calculation processing may be executed by a plurality of the information processing devices cooperating. Furthermore, the configuration of the above-described embodiment may be partially omitted, or the order of processing may be changed or the processing may be partially omitted.

In the present embodiment, the value of the distribution of the first input parameter and the value of the distribution of the second input parameter may each be a value an integrated value obtained from which is a probability value. As another example, the value of the distribution of the input parameter may be the probability value. In this case, the control unit 110 can use (Formula 42) instead of (Formula 7).

[Math 5]

As another example, the value of the distribution of the input parameter may be frequency instead of the probability value. In this case, the control unit 110 can use (Formula 43) instead of (Formula 5). Note that n is the total number of times.

[Math 6]

Furthermore, the control unit 110 may obtain the accumulation Pz′(zₖ) of the probability values or the accumulation of the frequencies using (Formula 44) based on the probability value distribution, and output the accumulation. Here, the right side indicates a value that is a sum of Pz(zₖ) from 0 to k.

[Math 7]

In the present embodiment, the unit length of the output parameter is the length of the range of the first partial region. The range of the first partial region can be set to any length. The length of the range of the first partial region may be longer or shorter than the unit length of z. Thus, there may be a gap between the first partial region of zₖ and the first partial region of zₖ₊₁, or the first partial region of zₖ and the first partial region of zₖ₊₁ may overlap each other. In any of the above cases regarding the first partial regions, the probability value of zₖ can be accurately obtained through the multiplication by the area of the corresponding second partial region. Furthermore, the first partial region may be set to change together with zₖ. Specifically, for example, the first partial region may be set to be 1 mm for zₖ, and to be 2 mm for zₖ₊₁. The first partial region only needs to have a width including zₖ, and may be a range centered on zₖ.

Furthermore, in the present embodiment, zₖ is set at an equal interval when the distribution of z is obtained, but the value of z obtained to obtain the distribution may not be values at an equal interval. Also in this case, the control unit 110 can obtain the distribution of z by performing interpolation for the probability values for the respective z values.

For example, when the ratio between the range of the distribution of the first input parameter and the range of the distribution of the second input parameter exceeds a predetermined range, that is, when a range of one value is largely different from a range of the other value, one of the distributions is highly unlikely to be reflected on the calculation result. Thus, in such a case, the control unit 110 performs the calculation using, as a numerical value, a smaller one of the input parameters defining the ratio. The numerical value in this case may be any value, and may be, for example, the average value, the maximum value, the minimum value, and the like in the range of this input parameter.

The control unit 110 of the present embodiment outputs the distribution of the output parameter. As another example, the control unit 110 may obtain, as the output, the probability value for predetermined zₖ, without obtaining the distribution. For example, when the user inputs the value of zₖ, the control unit 110 may obtain only the probability value for zₖ and output the probability value. Furthermore, the range dz of the first partial region in this case may be of any length, and may be settable according to a user operation, for example.

In the present embodiment, an example is described where the calculation is performed with the first input parameter and the second input parameter defined as two axes orthogonal to each other, but how the calculation is performed is not limited to that in the embodiment. As another example, the first input parameter and the second input parameter may be two axes that are not orthogonal to each other. In this case, the input parameter range, the first partial region, and the second partial region may be expressed in the coordinate system defined by such axes.

Furthermore, the embodiment can be implemented as a program or a method. The above-described device, program, and method may be implemented with a single device or may be implemented using components included in a plurality of devices, and thus include various aspects. Furthermore, variations can be made as appropriate to implement a configuration partially constituted by software and partially constituted by hardware and the like. The invention is also implementable with a recording medium for a program controlling a system. It is a matter of course that the recording medium for the program may be a magnetic recording medium or a semiconductor memory, and the above concept is directly applicable to any recording medium to be developed in the future.

### REFERENCE SIGNS LIST

100 INFORMATION PROCESSING DEVICE
110 CONTROL UNIT
112 ACQUISITION UNIT
113 SETTING UNIT
114 GENERATION UNIT
115 OUTPUT PROCESSING UNIT

1. An information processing device comprising:
an acquisition unit configured to acquire a first input distribution of a first input parameter and a second input distribution of a second input parameter;
a setting unit configured to set a first partial region including a first value, in a range of an output distribution of an output parameter obtained through calculation using the first input parameter and the second input parameter; and
a generation unit configured to obtain a value of a distribution for the first value, based on a value of a distribution of the first input parameter corresponding to the first value and a value of a distribution of the second input parameter corresponding to the first value within an input parameter range that is a range including the first input parameter and the second input parameter and determined based on the first input distribution and the second input distribution, and on a size of a second partial region that is included in the input parameter range and corresponds to the first partial region and a size of the first partial region.

2. The information processing device according to claim 1, wherein
the value of the distribution of the first input parameter is a probability value of the first input parameter, and
the value of the distribution of the second input parameter is a probability value of the second input parameter.

3. The information processing device according to claim 1, wherein
the value of the distribution of the first input parameter is a value an integrated value obtained from which is a probability value of the first input parameter, and
the value of the distribution of the second input parameter is a value an integrated value obtained from which a probability value of the second input parameter.

4. The information processing device according to claim 1, wherein
the value of the distribution of the first input parameter is a frequency of the first input parameter, and
the value of the distribution of the second input parameter is a frequency of the second input parameter.

5. The information processing device according to claim 1, wherein the generation unit sets, as the second partial region, a region that is within the input parameter range, and is defined by a straight line or a curve corresponding to the first value and the first partial region, and two auxiliary lines intersecting the straight line or the curve.

6. The information processing device according to claim 1, wherein the generation unit sets as the second partial region, a rectangular region obtained by dividing each of the first input parameter and second input parameter at an equal interval, when the calculation is addition or subtraction.

7. The information processing device according to claim 1, wherein the generation unit obtains as the value of the distribution of the first value, a value obtained by dividing a sum of products of the values of the distribution of the first input parameter and the distribution of the second input parameter respectively corresponding to combinations of the first input parameter and the second input parameter, the combinations each being the first value, and the size of the second partial region by the size of the first partial region.

8. The information processing device according to claim 1, wherein the setting unit divides the range of the output distribution with a predetermined unit, and sets the first partial region having same size for values, of the output parameter, corresponding to the unit.

9. The information processing device according to claim 8, wherein the generation unit obtains a value of a distribution for each of the values corresponding to the unit, and generates the output distribution based on the value of the distribution of each of the values.

10. The information processing device according to claim 1, wherein based on a correlation coefficient of the first input parameter and the second input parameter, the generation unit sets as the input parameter range, a first range or a second range, the first range being determined from a range of the first input distribution, the second range being a range smaller than the first range.

11. The information processing device according to claim 1, wherein when a ratio between the range of the first input distribution and the range of the second input distribution is out of a predetermined range, the generation unit obtains the value of the distribution for the first value, using an input parameter corresponding to a smaller one of the range of the first input distribution and the range of the second input distribution defining the ratio.

12. The information processing device according to claim 1, wherein when at least one of the range of the first input distribution and the range of the second input distribution includes discrete distribution values, the generation unit performs interpolation for the discrete distribution values, and obtains the value of the distribution for the first value based on the distribution values interpolated.

13. The information processing device according to claim 1, wherein when the first partial region and the second input parameter are of N-dimensional values, N being an integer that is equal to or larger than 2, and when calculation is performed as addition or subtraction between the first input parameter and the second input parameter, the generation unit sets the first partial region of same range for the first input parameter and the second input parameter.

14. The information processing device according to claim 1, wherein when the first input parameter is of a N-dimensional value, N being an integer that is equal to or larger than 2, the second input parameter is of a one-dimensional value, and the calculation is performed as multiplication or division between the first input parameter and the second input parameter, the generation unit obtains the value of the distribution for the first value based on a value of a distribution of a parameter on a straight line passing through the first value of the output parameter and an origin in an N-dimensional distribution of the first input parameter and the second input distribution.

15. The information processing device according to claim 1, wherein the generation unit sets the first partial region of a same range for two corresponding parameters in the calculation.

16. An information processing device comprising:
an acquisition unit configured to acquire a first input distribution of a first input parameter and a second input distribution of a second input parameter; and
a generation unit configured to generate a changed distribution by adding a unit change amount of the second input distribution to the first input distribution, and generate a minutely changed distribution corresponding to a minute change amount corresponding to the unit change amount based on the first input distribution and the changed distribution.

17. The information processing device according to claim 16, wherein the generation unit generates the minutely changed distribution through weighted averaging of at least one of parameter values and distribution values at a peak of each of the first input distribution and the changed distribution and points obtained by dividing each of the first input distribution and the changed distribution in a direction of height up to the peak.

18. A program causing a computer to function as:
an acquisition unit configured to acquire a first input distribution of a first input parameter and a second input distribution of a second input parameter;
a setting unit configured to set a first partial region including a first value, in a range of an output distribution of an output parameter obtained through calculation using the first input parameter and the second input parameter; and
a generation unit configured to obtain a value of a distribution for the first value, based on a value of a distribution of the first input parameter corresponding to the first value and a value of a distribution of the second input parameter corresponding to the first value within an input parameter range that is a range defined by the first input parameter and the second input parameter and on a size of a second partial region that is included in the input parameter range and corresponds to the first partial region and a size of the first partial region.

19. A program causing a computer to function as:
an acquisition unit configured to acquire a first input distribution of a first input parameter and a second input distribution of a second input parameter; and
a generation unit configured to generate a changed distribution by adding a unit change amount of the second input distribution to the first input distribution, and generate a minutely changed distribution corresponding to a minute change amount corresponding to the unit change amount based on the first input distribution and the changed distribution.
